(19) United States
(12) Patent Application Publication
(10) Pub. No.: US 2025/0034749 A1
(43) Pub. Date: Jan. 30, 2025

(54) AUTOMATIC DECISION-MAKING FOR PULLING

(71) Applicant: TCL ZHONGHUAN RENEWABLE ENERGY TECHNOLOGY CO., LTD., Tianjin (CN)

(72) Inventors: Ruichuan SHEN, Tianjin (CN); Runfei GAO, Tianjin (CN); Shichao ZHANG, Tianjin (CN); Xuefeng LI, Tianjin (CN); Enhui DONG, Tianjin (CN); Ming YAN, Tianjin (CN); Yuefeng LI, Tianjin (CN)

(73) Assignee: TCL ZHONGHUAN RENEWABLE ENERGY TECHNOLOGY CO., LTD., Tianjin (CN)

(21) Appl. No.: 18/548,092

(22) PCT Filed: Jun. 29, 2023
(86) PCT No.: PCT/CN2023/103935

§ 371 Date: Aug. 27, 2023

(30) Foreign Application Priority Data
Jul. 29, 2022 (CN) 202210915273.3

(51) Int. Cl. C30B 15/20; G06F 30/27; G06F 119/08; H01L 31/18

(52) U.S. Cl. CPC C30B 15/206; G06F 30/27; G06F 2119/08; H01L 31/1804

(57) ABSTRACT

The present application relates to automatic decision-making for pulling. Multi-dimensional data cleaning is performed and dimensional data warehouse is established by processing, filtering and converting basic source data of pulling nodes in a pulling process for monocrystal pulling-up into data sets easily identified and marked and establishing respective models based thereon. Basic source data of a current pulling nodes are obtained and converted into process parameters. The process parameters are compared with respective models in the dimensional data warehouse to obtain a first determination result. Data analysis is performed on the first determination result to determine whether an abnormality occurs in the current pulling process to obtain a second determination result. Decision is made automatically based on the second determination result.

### CROSS-REFERENCE TO RELATED APPLICATION

This application claims priority to and the benefit of Chinese Patent Application No. 2022109115273.3, filed on Jul. 29, 2022, the disclosure of which is hereby incorporated by reference in its entirety.

### TECHNICAL FIELD

The present application relates to production of photovoltaic monocrystal by pulling-up, and particularly to automatic decision-making for pulling.

### BACKGROUND

When bract breakage occurs in the production of monocrystal by pulling-up, different types of pulling actions need to be performed. An end of monocrystalline silicon in which the bract breakage occurs may continue to grow and is less stable, due to change of the structure of its crystal body, than the monocrystalline silicon, and thus an abnormality such as diameter fluctuation is easy to occur. When the length of pulling exceeds a certain interval, a cost is wasted. Moreover, a monocrystal explosion phenomenon is easy to occur due to thermal stress inside the crystal.

In an actual production process, an abnormal condition of the pulling furnace is judged and decision is made by an engineer manually, and it is necessary to repeat the manual inspection of the furnace until decision is made manually at a decision time point, so that the timeliness and efficiency are low. Moreover, the manual inspection has the risk of missing the inspection, which may result in a potential great safety hazard.

### SUMMARY

In view of the above, the present disclosure provides a method of automatic decision-making for pulling, including:
obtaining basic source data of pulling nodes for respective furnaces of respective series of a plurality of types in a pulling process for monocrystal pulling-up;
processing the obtained basic source data to filter and convert the basic source data into a plurality of parameters easily identified and marked in the pulling nodes, and obtaining a data set of respective values of the plurality of parameters;
establishing respective models for the plurality of the parameters by deep learning based on the data set;
performing analysis, calculation, fitting and optimization on each of the models by the deep learning to obtain an optimal monocrystal temperature model and an optimal pulling length model in the pulling process for monocrystal pulling-up;
performing analysis and calculation on each of the models by the deep learning to obtain first basic source data of a monocrystal temperature and a pulling length of a pulling node for current furnace of current series of current type;
processing the obtained first basic source data to filter and convert the first basic source data into process parameters, easily identified and marked, of the monocrystal temperature and the pulling length;
comparing the process parameters of the monocrystal temperature and the pulling length respectively with the optimal monocrystal temperature model and the optimal pulling length model to obtain a comparison result, and determining, based on the comparison result, whether respective values of the process parameters of the pulling node where the monocrystal is located are reasonable to obtain a first determination result; and
performing data analysis on the first determination result by the deep learning to determine whether an abnormality occurs in a current pulling process to obtain a second determination result, and make a decision based on the second determination result.

The present disclosure further provides a computer device including: a processor; and a memory storing a computer program executable by the processor to perform the above method.

The present disclosure further provides a non-transitory computer readable storage medium storing a computer program executable by a processor to perform the above method.

### BRIEF DESCRIPTION OF THE DRAWINGS

FIG. 1 is a flowchart of a method of automatic decision-making for pulling according to an embodiment of the present application.

FIG. 2 illustrates a flowchart of a system of automatic decision-making for pulling according to an embodiment of the present application.

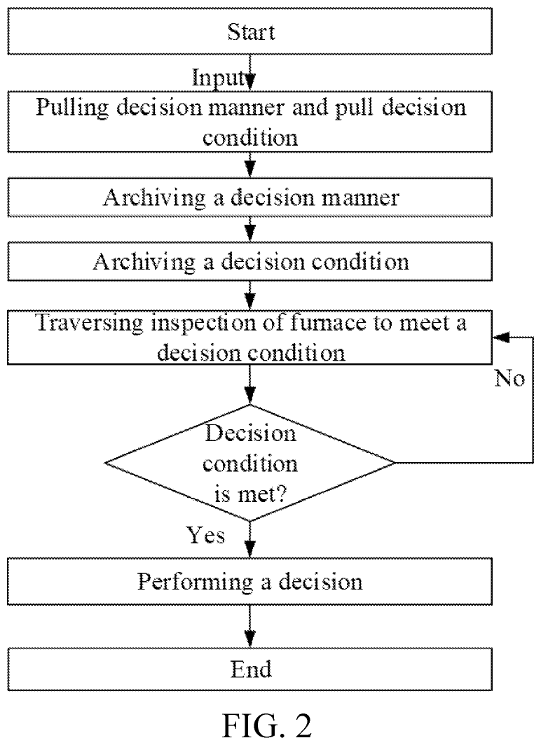

### DETAILED DESCRIPTION

The present application is further described below with reference to the embodiments and the accompanying drawings.

In order to make the objects, technical solutions and advantages of the present application clearer, the present application will now be described in further detail with reference to the following detailed description, taken in conjunction with the accompanying drawings. It should be understood that these descriptions are exemplary only and are not intended to limit the scope of the present application. In addition, in the following description, descriptions of well-known structures and techniques are omitted so as not to unnecessarily obscure the concepts of the present application.

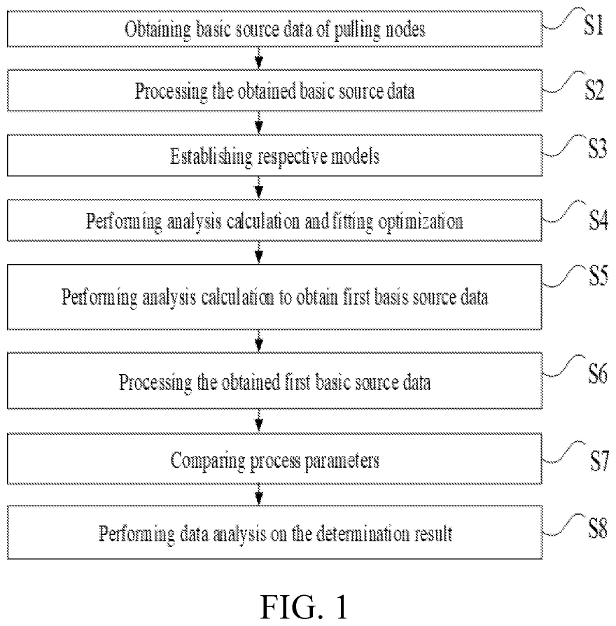

As shown in FIG. 1, an embodiment of the present application provides a method of automatic decision-making for pulling, including following steps S1-S8.

At step S1, basic source data of pulling nodes for respective furnaces of respective series of a plurality of types in a pulling process for monocrystal pulling-up is obtained.

Specifically, the basic source data of the pulling nodes includes at least one of production process data, raw auxiliary material data or quality data.

The production process data may include a device name, start and end time, a batch number, a process pattern, a recipe name, a diameter measurement value, a thermal field temperature value, a main heater power measurement, a bottom heater power measurement, an actual crystal pulling speed, and the like.

The raw auxiliary material data may include a material preparation date, a dosing number, a personnel shift, a furnace time, a workpiece specification, a crucible type, a crucible origin, a raw polycrystalline weight, a recovery material proportion, an overall weight, and the like.

The quality data may include monocrystal numbering, length, weight, diameter, resistivity, lifetime, oxygen content, carbon content, defects, and the like.

At step S2, the obtained basic source data is processed to filter and convert the basic source data into a plurality of parameters easily identified and marked in the pulling nodes, and obtaining a data set of respective values of the plurality of parameters.

Specifically, the basic source data is processed, filtered, and converted into a plurality of parameters easily identified and marked in the pulling nodes, to obtain a data set of respective values of the parameters. That is, the scattered, chaotic, and standard non-uniform source data in the input basic source data are integrated, and then converted into a common parameter data set in the workpiece processing node, thereby providing a basis for subsequent parameter comparison and decision analysis.

Further, each of the plurality of parameters is established based on a production region, a duration of a pulling action and a pulling function.

Further, all of the plurality of parameters are configured to be displayed in a terminal display of a single crystal furnace.

At step S3, respective models are established for the plurality of the parameters by deep learning based on the data set.

Specifically, the respective models are established for each of the parameters by the deep learning method, so as to monitor the node analysis and determination of all the workpieces during the pulling process to obtain a monocrystal workpiece of which the quality meets the standard. The deep learning is based on a conventional deep learning model in the art of machine learning. For example, the deep learning may be based on at least one of a convolution neural network, a recurrent neural network, a generative adversarial network, or deep reinforcement learning, which are well known in the art.

At step S4, analysis, calculation, fitting and optimization are performed on each of the models by the deep learning to obtain an optimal monocrystal temperature model and an optimal pulling length model in the pulling process for monocrystal pulling-up.

Specifically, analysis, calculation, fitting and optimization are performed on each of the models by the deep learning to obtain an optimal monocrystal temperature model and an optimal pulling length model in the pulling process for monocrystal pulling-up.

At step S5, analysis and calculation are performed on each of the models by the deep learning to obtain first basic source data of a monocrystal temperature and a pulling length of a pulling node for current furnace of current series of current type.

At step S6, the obtained first basic source data is processed to filter and convert the first basic source data into process parameters, easily identified and marked, of the monocrystal temperature and the pulling length.

Further, the plurality of parameters for the pulling nodes correspond to respective types of the process parameters.

At step S7, the process parameters of the monocrystal temperature and the pulling length are compared respectively with the optimal monocrystal temperature model and the optimal pulling length model to obtain a comparison result, and whether respective values of the process parameters of the pulling node where the monocrystal is located are reasonable is determined based on the comparison result to obtain a first determination result.

At step S8, data analysis is performed on the first determination result by the deep learning to determine whether an abnormality occurs in a current pulling process to obtain a second determination result, and make a decision based on the second determination result.

A system of automatic decision-making for pulling includes:
a source data obtaining unit for obtaining basic source data of pulling nodes for respective furnaces of respective series of a plurality of types in a pulling process for monocrystal pulling-up;
a source data processing unit for processing the obtained basic source data to filter and convert the basic source data into a plurality of parameters easily identified and marked in the pulling nodes, and obtaining a data set of respective values of the plurality of parameters;
a model establishing unit for establishing respective models for the plurality of the parameters by deep learning based on the data set;
a data cleaning unit for performing multi-dimensional data cleaning on each of the models to establish dimensional data warehouse of the pulling process for monocrystal pulling-up;
a data comparison unit for comparing process parameters with respective models to obtain a first determination result; and
a big data platform unit for performing a big data analysis on the first determination result, to determine whether an abnormality occurs in a current pulling process to obtain a second determination result, and make a decision based on the second determination result.

Further, the plurality of parameters for the pulling nodes correspond to respective types of the process parameters;
each of the plurality of parameters is established based on a production region, a duration of a pulling action and a pulling function; and
all of the plurality of parameters are configured to be displayed in a terminal display of a single crystal furnace.

Further, the basic source data of the pulling nodes includes at least one of production process data, raw auxiliary material data or quality data.

Another embodiment of the present application further provides a computer device, including: a processor; and a memory storing a computer program executable by the processor to perform the steps of the method of automatic decision-making for pulling as described in any one of the above.

Another embodiment of the present application further provides a non-transitory computer readable storage medium stores a computer program executable by a processor to perform the steps of the method of automatic decision-making for pulling as described in any one of the above.

The advantages and beneficial effects achieved by the present application are:
1. the method of automatic decision-making for pulling, the system of automatic decision-making for pulling, the computer device and the non-transitory computer readable storage medium designed by the present application are used to process, filter and convert the basic source data of the pulling nodes in the pulling process for monocrystal pulling-up into the plurality of parameters easily identified and marked in the pulling nodes; establishing respective models for the plurality of the parameters by deep learning based on the data set, and performing multi-dimensional data cleaning on each of the models to establish the dimensional data warehouse of the pulling process for monocrystal pulling-up; obtain current basic source data of the current pulling node with calculation, and filter and convert the current basic source data into process parameters easily identified and marked in the pulling node, and compares them with each model in the dimensional data warehouse so as to determine whether the values of the process parameters easily identified and marked in the node where the monocrystal is located are reasonable to obtain the first determination result; performing data analysis on the first determination result by deep learning, to determine whether the current pulling process is abnormal or not to obtain a second determination result, and making the decision according to the second determination result.
2. the technical solution of the present application can, when an abnormal condition occurs in the pulling process of the monocrystal pulling-up, automatically give the optimal evaluation and decision in time, reduce the interference of workers, decrease the waste of work hours, improve the production yield, implement an automatic decision, deal with an abnormal problem in a more real-time, comprehensive, accurate and standard manner, and improve the production efficiency and the product quality. Manual inspection and manual processing are not required, timeliness and efficiency are enhanced, and the potential great safety hazard is reduced.

It should be understood that the above-described embodiments of the present application are merely illustrative or explanatory of the principles of the present application and are not to be construed as limiting the present application. Accordingly, any modifications, equivalents, modifications and the like which may be made without departing from the spirit and scope of the present application are intended to be included within the scope of the present application. Furthermore, the appended claims of the present application are intended to cover all changes and modifications that fall within the scope and boundaries of the appended claims, or equivalents of such scope and boundaries.

What is claimed is:

1. A method of automatic decision-making for pulling, comprising:
obtaining basic source data of pulling nodes for respective furnaces of respective series of a plurality of types in a pulling process for monocrystal pulling-up;
processing the obtained basic source data to filter and convert the basic source data into a plurality of parameters easily identified and marked in the pulling nodes, and obtaining a data set of respective values of the plurality of parameters;
establishing respective models for the plurality of the parameters by deep learning based on the data set;
performing analysis, calculation, fitting and optimization on each of the models by the deep learning to obtain an optimal monocrystal temperature model and an optimal pulling length model in the pulling process for monocrystal pulling-up;
performing analysis and calculation on each of the models by the deep learning to obtain first basic source data of a monocrystal temperature and a pulling length of a pulling node for current furnace of current series of current type;
processing the obtained first basic source data to filter and convert the first basic source data into process parameters, easily identified and marked, of the monocrystal temperature and the pulling length;
comparing the process parameters of the monocrystal temperature and the pulling length respectively with the optimal monocrystal temperature model and the optimal pulling length model to obtain a comparison result, and determining, based on the comparison result, whether respective values of the process parameters of the pulling node where the monocrystal is located are reasonable to obtain a first determination result; and
performing data analysis on the first determination result by the deep learning to determine whether an abnormality occurs in a current pulling process to obtain a second determination result, and make a decision based on the second determination result.

2. The method of claim 1, wherein the plurality of parameters for the pulling nodes correspond to respective types of the process parameters.

3. The method of claim 2, wherein each of the plurality of parameters is established based on a production region, a duration of a pulling action and a pulling function.

4. The method of claim 3, wherein all of the plurality of parameters are configured to be displayed in a terminal display of a single crystal furnace.

5. The method of claim 1, wherein the basic source data of the pulling nodes comprises at least one of production process data, raw auxiliary material data or quality data.

6. The method of claim 2, wherein the basic source data of the pulling nodes comprises at least one of production process data, raw auxiliary material data or quality data.

7. The method of claim 3, wherein the basic source data of the pulling nodes comprises at least one of production process data, raw auxiliary material data or quality data.

8. The method of claim 4, wherein the basic source data of the pulling nodes comprises at least one of production process data, raw auxiliary material data or quality data.

9. A computer device comprising:
a processor; and
a memory storing a computer program executable by the processor to perform operations comprising:
obtaining basic source data of pulling nodes for respective furnaces of respective series of a plurality of types in a pulling process for monocrystal pulling-up;
processing the obtained basic source data to filter and convert the basic source data into a plurality of parameters easily identified and marked in the pulling nodes, and obtaining a data set of respective values of the plurality of parameters;
establishing respective models for the plurality of the parameters by deep learning based on the data set;
performing analysis, calculation, fitting and optimization on each of the models by the deep learning to obtain an optimal monocrystal temperature model and an optimal pulling length model in the pulling process for monocrystal pulling-up;
performing analysis and calculation on each of the models by the deep learning to obtain first basic source data of a monocrystal temperature and a pulling length of a pulling node for current furnace of current series of current type;
processing the obtained first basic source data to filter and convert the first basic source data into process parameters, easily identified and marked, of the monocrystal temperature and the pulling length;
comparing the process parameters of the monocrystal temperature and the pulling length respectively with the optimal monocrystal temperature model and the optimal pulling length model to obtain a comparison result, and determining, based on the comparison result, whether respective values of the process parameters of the pulling node where the monocrystal is located are reasonable to obtain a first determination result; and
performing data analysis on the first determination result by the deep learning to determine whether an abnormality occurs in a current pulling process to obtain a second determination result, and make a decision based on the second determination result.

10. The computer device of claim 9, wherein the plurality of parameters for the pulling nodes correspond to respective types of the process parameters.

11. The computer device of claim 10, wherein each of the plurality of parameters is established based on a production region, a duration of a pulling action and a pulling function.

12. The computer device of claim 11, wherein all of the plurality of parameters are configured to be displayed in a terminal display of a single crystal furnace.

13. The computer device of claim 9, wherein the basic source data of the pulling nodes comprises at least one of production process data, raw auxiliary material data or quality data.

14. The computer device of claim 10, wherein the basic source data of the pulling nodes comprises at least one of production process data, raw auxiliary material data or quality data.

15. The computer device of claim 11, wherein the basic source data of the pulling nodes comprises at least one of production process data, raw auxiliary material data or quality data.

16. The computer device of claim 12, wherein the basic source data of the pulling nodes comprises at least one of production process data, raw auxiliary material data or quality data.

17. A non-transitory computer readable storage medium storing a computer program executable by a processor to perform operations comprising:
obtaining basic source data of pulling nodes for respective furnaces of respective series of a plurality of types in a pulling process for monocrystal pulling-up;
processing the obtained basic source data to filter and convert the basic source data into a plurality of parameters easily identified and marked in the pulling nodes, and obtaining a data set of respective values of the plurality of parameters;
establishing respective models for the plurality of the parameters by deep learning based on the data set;
performing analysis, calculation, fitting and optimization on each of the models by the deep learning to obtain an optimal monocrystal temperature model and an optimal pulling length model in the pulling process for monocrystal pulling-up;
performing analysis and calculation on each of the models by the deep learning to obtain first basic source data of a monocrystal temperature and a pulling length of a pulling node for current furnace of current series of current type;
processing the obtained first basic source data to filter and convert the first basic source data into process parameters, easily identified and marked, of the monocrystal temperature and the pulling length;
comparing the process parameters of the monocrystal temperature and the pulling length respectively with the optimal monocrystal temperature model and the optimal pulling length model to obtain a comparison result, and determining, based on the comparison result, whether respective values of the process parameters of the pulling node where the monocrystal is located are reasonable to obtain a first determination result; and
performing data analysis on the first determination result by the deep learning to determine whether an abnormality occurs in a current pulling process to obtain a second determination result, and make a decision based on the second determination result.

18. The computer readable storage medium of claim 17, wherein the plurality of parameters for the pulling nodes correspond to respective types of the process parameters.

19. The computer readable storage medium of claim 18, wherein each of the plurality of parameters is established based on a production region, a duration of a pulling action and a pulling function.

20. The computer readable storage medium of claim 19, wherein all of the plurality of parameters are configured to be displayed in a terminal display of a single crystal furnace.
